(19) United States
(12) Patent Application Publication
(10) Pub. No.: US 2008/0077912 A1
(43) Pub. Date: Mar. 27, 2008

(54) Software development methods, systems, and storage media storing software developed thereby

(75) Inventor: Wei Zhang, Shanghai City (CN)

Correspondence Address: BIRCH STEWART KOLASCH & BIRCH, PO BOX 747, FALLS CHURCH, VA, 22040-0747, US

(73) Assignee: Winbond Electronics Corp.

(21) Appl. No.: 11/882,302

(22) Filed: Jul. 31, 2007

(30) Foreign Application Priority Data
Sep. 22, 2006 (TW) 95135104

(51) Int. Cl. G06F 9/45

(52) U.S. Cl. 717/151

(57) ABSTRACT

A software development method is provided. Definition of one or more sections in program source code is retrieved. The section definition indicates the range and a corresponding main memory address of each section. The source code is compiled to generate an executable file according to the section definition, such that, the executable codes generated from the one or more sections are loaded from a nonvolatile memory to corresponding addresses on a main memory to be delivered to and executed by the processor while the remaining instructions in the executable file are delivered to the processor for execution from the nonvolatile memory.

### BACKGROUND OF THE INVENTION

1. Field of the Invention

The invention relates to computer techniques, and more particularly to memory access and software development methods and systems.

2. Description of the Related Art

Storage media for storing video games are as varies as the diversity of game console designs. For example, games suitable for Playstation 2 and Xbox are stored on compact discs while games for Game Boy are stored in mask ROM or ROM chips.

Access speed of ROM chips is fast enough for a game console to directly read and fluidly execute game programs stored therein without requiring advance loading of game programs in main memory. The access speed of ROM chips, however, is still much slower than random-access memory (RAM), and thus, game execution efficiency may be affected. Adding RAM to improve performance, however, increases game console cost.

### BRIEF SUMMARY OF THE INVENTION

Methods for software development are provided. An exemplary embodiment of a software development method is implemented in a software development system. Source code of a program is retrieved. The definition of one or more sections of the source code is also retrieved, wherein the definition comprises range and address information indicating a range and a corresponding main memory address of each section respectively. The source code of the program is compiled to generate an executable file according to the range and address information. When the executable file is executed by a processor, the executable codes generated from the one or more sections are loaded from a nonvolatile memory to the corresponding main memory addresses thereof in a main memory to be delivered to and executed by the processor while the remaining instructions in the executable file are delivered to the processor for execution from the nonvolatile memory.

An exemplary embodiment of a computer-readable storage medium comprises a nonvolatile memory storing an executable file of a computer program. The executable file, when loaded to a computer comprising a processor and a main memory, directs the computer to perform the following steps. When the processor executes the executable file, one or more sections of instructions in the executable file are loaded from a nonvolatile memory to the corresponding main memory addresses in a main memory. The one or more sections are fetched from the main memory to the processor for execution. The remaining instructions in the executable file are fetched from the nonvolatile memory and delivered to the processor for execution.

Software development systems are provided. An exemplary embodiment of a software development system comprises a compiler and a linker. The compiler retrieves definition of one or more sections in the source code of a program. The definition comprises range and address information indicating a range and a corresponding main memory address of each section respectively. The compiler further compiles the source code to generate object code of the program according to the range and address information. The linker generates an executable file of the program according to the object code and the definition, such that, when the executable file is executed by a processor, the executable codes generated from the one or more sections are loaded from a nonvolatile memory to the corresponding main memory addresses thereof in a main memory to be delivered to and executed by the processor while the remaining instructions in the executable file are delivered to the processor for execution from the nonvolatile memory.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart showing an exemplary embodiment of a software development method;

FIG. 2 is a schematic view showing an example of source code and an executable file;

FIG. 3 is a flowchart showing operations directed by a move instruction;

FIG. 4 is a block diagram of the configuration of a game console executing the executable file; and

FIG. 5 is a schematic diagram of an exemplary embodiment of a software development system.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Software development methods and systems are provided in the following, by which a mechanism allowing a programmer to personally program runtime memory management in the programming stage is provided. That is, a program developed from said mechanism can guide instructions via fetching routes to a processor during program runtime.

### A First Exemplary Embodiment

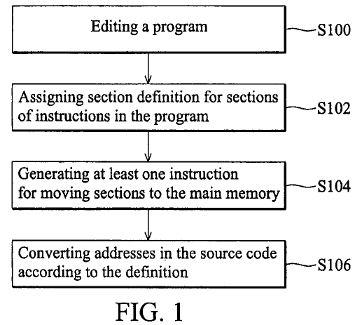

An exemplary embodiment of a software development method is described with reference to FIG. 1.

First, a software designer edits a program in a programming language, such as C, C++, java or others (step S100), and assigns section definition for one or more sections of instructions in the program (step S102), indicating the one or more sections in the program to be loaded to a main memory of a computer before execution. The software development system may comprise an editor, a compiler, and a linker, and provide a programming language standard for describing the definition. The definition may comprise range information indicating the range of each section, and address information indicating a corresponding main memory address of each section.

When editing of the source code is completed, the software development system compiles the source code of the program to generate an executable file according to the definition. The executable file may comprise game software. The software development method, however, may be applied to various types of software. The software development system generates at least one move instruction for moving the one or more sections to the main memory (step S104) according to the definition, converts symbol addresses in the source code to logical or physical addresses in the main memory (step S106). Thus, the one or more sections can be referenced by the remaining instructions in the executable file even if duplicated and moved to the main memory.

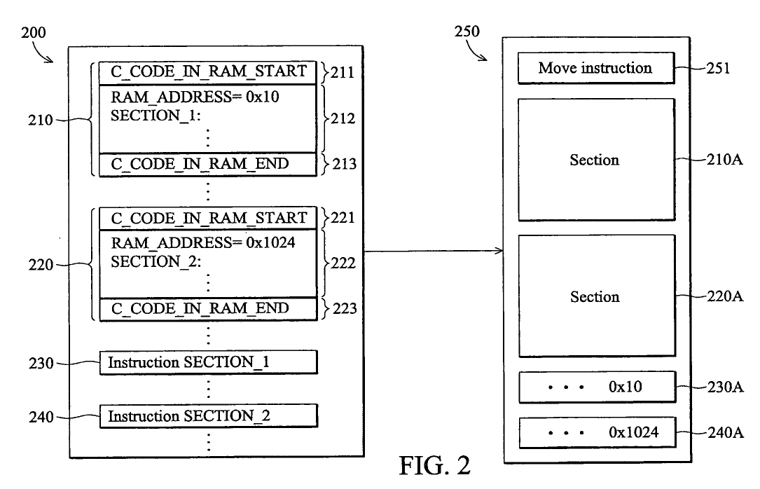

FIG. 2 shows an example of source code and an executable file. Source code 200 comprises sections 210 and 220. Tags 211 and 213 indicate the beginning and ending addresses of section 210. Instructions 212 in section 210 comprises a corresponding main memory address RAM_ADDRESS, the value of which is 0x10, and a symbol address SECTION_1. The mentioned information forms the definition of section 210. The definition of section 220 comprises tags 221 and 223 respectively indicating the beginning and ending addresses of section 220, a corresponding main memory address RAM_ADDRESS=0x1024 of section 220, and a symbol address SECTION_2 of instructions 222.

Sections 210 and 220 are both program instructions and comprise section definition (including RAM_ADDRESS, C_CODE_IN_RAM_START, and C_CODE_IN_RAM_END). The executable file compiled from source code 200 comprises instructions compiled from sections 210 and 220 (such as 210A and 220A in FIG. 2) and may exclude the section definition. Sections 210A and 220A are copied to the main memory during program runtime.

Note that section definition of each source code file may define one or more sections. The range size of a section may be freely defined and adjusted. For example, a section may comprise one or more functions or subroutines. Alternatively, one function or subroutine may span one or more sections. In addition to section 210 and 220, source code 200 further comprises the i-th instruction 230 referring to symbol address SECTION_1 in section 210, and j-th instruction 240 referring to symbol address SECTION_2 in section 220, wherein i and j are both integers. Note that source code 200 may have more instructions for execution referring to and invoking sections 210 and 220.

Source code 200 is compiled to generate executable file 250. Executable file 250 is subsequently written to nonvolatile memory, such as read only memory (ROM) chip. The i-th instruction 230 and j-th instruction 240 are respectively converted to instructions 230A and 240A while symbol addresses SECTION_1 and SECTION_2 are respectively converted to main memory addresses 0x10 and 0x1024 corresponding to sections 210 and 220.

Instruction sections 210A and 220A are instructions, such as machine codes, generated and compiled from sections 210 and 220. Instruction sections 210A and 220A may comprise the section definitions or a customized move instruction to substitute for the definitions. Move instruction 251 is generated for copying sections 210A and 220A to a main memory for execution. Move instruction 251 may directly load operations of sections 210A and 220A when initializing execution of executable file 250 or upon request for execution of sections 210A and 220A. The software development system may customize move instructions according to respective section definitions or provide a common move instruction directing loading operations of respective sections to a main memory according to respective definitions thereof.

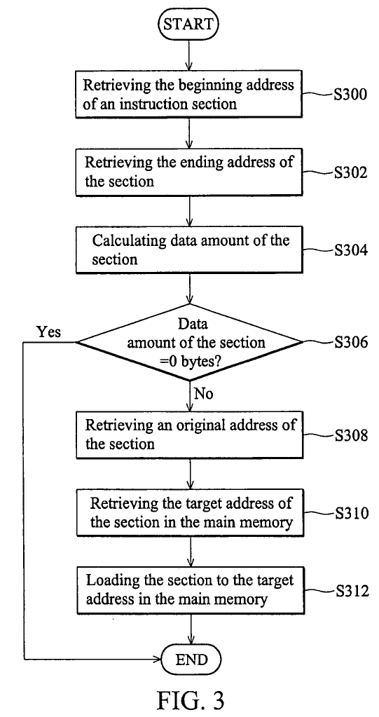

FIG. 3 shows the flowchart of operations directed by move instruction 251.

When executing a move instruction 251, a computer performs the following steps:

First, the beginning address of an instruction section in a non-volatile memory is retrieved (step S300), such as the address of tag 211 or 221, wherein the addresses of tag 211 and 221 have been determined after processing by the linker. The ending address of the instruction section in a non-volatile memory is also retrieved (step S302), such as the address of tag 213 or 223, wherein the addresses of tag 213 and 223 have been determined after processing by the linker. The section data amount is calculated according to the beginning and ending addresses (step S304). It is determined if the data amount is 0 bytes (step S306). If so, execution of move instruction 251 is terminated. If not, an address of the section in the non-volatile memory is retrieved, such as the addresses converted from symbol addresses SECTION_1 and SECTION_2 (step S308) and the target addresses in the main memory of the computer, such as 0x10 and 0x1024 (step S310). The section is loaded to the target addresses in the main memory (step S312).

One or more instructions in an instruction set of a processor may implement the loading operations of one or more sections from a non-volatile memory to a main memory. Note that if section definitions are excluded from sections 210A and 220A, sections 210A and 220A may comprise customized move instructions for respectively loading sections 210A and 220A to the main memory, as described in steps S308˜312.

Executable file 250 is written to a non-volatile memory, such as a ROM chip, flash memory, loaded to erasable programmable ROM (EPROM), and electrically erasable programmable ROM (EEPROM).

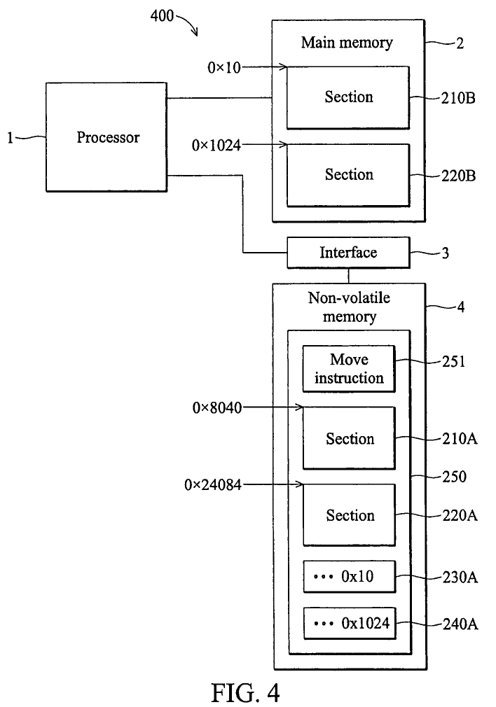

FIG. 4 is a schematic diagram showing the configuration of game console 400 executing the executable file. Non-volatile memory 4 is connected to interface 3 of game console 400. Processor 1 is coupled to main memory 2 and interface 3. Main memory 2 may comprise random access memory (RAM), such as static random access memory (SRAM) or dynamic random access memory (DRAM).

When game console 400 boots, processor 1 may directly read and execute programs in non-volatile memory 4. As shown in FIG. 3, according to move instruction 251, processor 1 may load sections 210A and 220A when executing executable file 250. Alternatively, processor 1 may respectively load sections 210A or 220A when execution of sections 210A or 220A is required.

When executing executable file 250, processor 1 fetches remaining instructions (such as 230A and 240A) other than sections 210A and 220A in executable file 250 from non-volatile memory 4, loads sections 210A and 220A from non-volatile memory 4 to respective corresponding addresses in main memory 2, and fetches instructions in sections 210A and 220A from main memory 2. Sections 210A and 220A, rather than 230A and 240A, are moved to main memory 2 during runtime. 230A and 240A can invoke 210B and 220B.

For example, the corresponding address of section 210A is 0x10 in main memory 2. Processor 1 loads section 210A to byte address 0x10 in main memory 2 to form section 210B. That is, section 210A is loaded to the location in main memory 2 beginning from the corresponding address. Similarly, processor 1 may load section 220A to byte address 0x1024 in main memory 2 to form section 220B. Instructions 230A and 240A can refer to corresponding addresses in main memory 2 for executing sections 210B and 220B.

When execution of a section in main memory 2 is complete, the section returns execution control to instructions in non-volatile memory 4, such as instructions 230A and 240A, other subroutines revoking the section, thus enabling instructions in executable file 250 to be resumed by processor 1.

### The Second Exemplary Embodiment

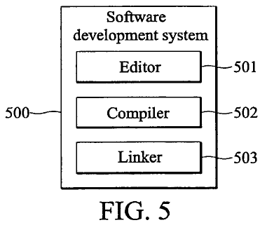

FIG. 5 shows a software development system 500.

In software development system 500, editor 501 generates source code of a program, and assigns section definition to one or more instruction sections therein. The section definition comprises range information indicating the range of each section, and address information indicating a corresponding main memory address of each section. The range information may comprise the beginning and ending addresses of each of the one or more sections.

Compiler 502 retrieves the definition of one or more sections in source code of a program, compiling the source code to generate object code of the program according to the range and address information. The compiler, according to the definition, generates at least one move instruction in the object code for moving the one or more sections to the main memory of the computer.

Linker 503 generates an executable file of the program according to the object code and the definition. The source code comprises a symbol address referring to one of the one or more sections. The linker converts the symbol address to a logical address in the main memory according to the address information. The one or more sections are compiled and linked to generate one or more sections of executable codes.

The executable file is stored in a non-volatile memory. When the executable file is loaded to a computer comprising a processor, the processor executes instructions in the executable file, sections of the executable codes are loaded from the nonvolatile memory to the corresponding main memory addresses in the main memory to be fetched and delivered to the processor for execution while the remaining instructions in the executable file are delivered to the processor for execution from the nonvolatile memory.

Thus, the method allows frequently executed instructions in a non-volatile memory to be loaded to a main memory while other instructions are left in the non-volatile memory. The instructions to be loaded to a main memory are definable by a designer in the programming stage. Various ranges of sections can be defined in the section definitions.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A software development method, implemented in a software development system, comprising:
retrieving source code of a program;
retrieving the definition of one or more sections of the source code, wherein the definition comprises range and address information indicating a range and a corresponding main memory address of each section respectively;
compiling the source code of the program to generate an executable file according to the range and address information, such that, when the executable file is executed by a processor, the executable codes generated from the one or more sections are loaded from a nonvolatile memory to the corresponding main memory addresses thereof in a main memory to be delivered to and executed by the processor while the remaining instructions in the executable file are delivered to the processor for execution from the nonvolatile memory.

2. The method as claimed in claim 1, the compiling step further comprises:
generating at least one move instruction in the executable file for moving the executable codes therein generated from the one or more sections to the main memory.

3. The method as claimed in claim 1, wherein the source code comprises a symbol address referring to one of the one or more sections, the method further comprising:
converting the symbol address to a logic address or a physical address on the main memory according to the address information.

4. The method as claimed in claim 1, further comprising:
providing a programming language standard for describing the definition.

5. The method as claimed in claim 1, further comprising:
providing an instruction set with an instruction for moving the executable codes therein generated from the one or more sections to the main memory.

6. The method as claimed in claim 4, wherein the range information comprises beginning and ending addresses of each of the one or more sections.

7. A computer-readable storage medium, comprising a nonvolatile memory storing an executable file of a computer program, wherein the executable file, when loaded to a computer comprising a processor and a main memory, directs the computer to perform steps of:
when the processor executes the executable file, loading one or more sections of instructions in the executable file from a nonvolatile memory to the corresponding main memory addresses thereof in a main memory;
fetching the one or more sections from the main memory to the processor for execution; and
fetching remaining instructions in the executable file from the nonvolatile memory to the processor for execution.

8. The computer-readable storage medium as claimed in claim 7, wherein the executable file comprises game software.

9. The computer-readable storage medium as claimed in claim 7, wherein the nonvolatile memory comprises a portable storage device.

10. The computer-readable storage medium as claimed in claim 7, wherein the nonvolatile memory comprises a read-only memory (ROM) chip.

11. The computer-readable storage medium as claimed in claim 7, wherein the computer comprises a game console.

12. A software development system, comprising:
a compiler retrieving definition of one or more sections in source code of a program, wherein the definition comprises range and address information indicating a range and a corresponding main memory address of each section respectively, the compiler further compiles the source code to generate object code of the program according to the range and address information; and
a linker generating an executable file of the program according to the object code and the definition, such that, when the executable file is executed by a processor, the executable codes generated from the one or more sections are loaded from a nonvolatile memory to the corresponding main memory addresses thereof in a main memory to be delivered to and executed by the processor while the remaining instructions in the executable file are delivered to the processor for execution from the nonvolatile memory.

13. The system as claimed in claim 12, wherein the compiler, according to the definition, generates at least one move instruction in the object code for moving the one or more sections to the main memory.

14. The method as claimed in claim 12, wherein the source code comprises a symbol address referring to one of the one or more sections, the linker converts the symbol address to a logic address or a physical address on the main memory according to the address information.

15. The method as claimed in claim 12, wherein the range information comprises beginning and ending addresses of each of the one or more sections.

16. The method as claimed in claim 12, further comprising:
an instruction set comprising an instruction for moving the executable codes therein generated from the one or more sections from the nonvolatile memory to the main memory.
